(19) United States
(12) Patent Application Publication
(10) Pub. No.: US 2023/0259801 A1
(43) Pub. Date: Aug. 17, 2023

(54) Semantic-Based Causal Event Probability Analysis Method, Apparatus and System

(71) Applicant: Siemens Aktiengesellschaft, München (DE)

(72) Inventors: Wen Chao Zou, Shanghai (CN); Hai Feng Wang, Shanghai (CN); Arquimedes Martinez Canedo, Plainsboro, NJ (US)

(73) Assignee: Siemens Aktiengesellschaft, München (DE)

(21) Appl. No.: 18/003,695

(22) PCT Filed: Jun. 30, 2020
(86) PCT No.: PCT/CN2020/099505

§ 371 Date: Dec. 29, 2022

(51) Int. Cl. G06N 7/01; G06N 5/02

(52) U.S. Cl. CPC G06N 7/01; G06N 5/02

(57) ABSTRACT

Various embodiments include a semantic-based causal event probability analysis method. The method may include: generating a cause event instance and corresponding effect event instances thereof according to user requirements and based on a cause event template and an effect event template; assigning each cause event or effect event instance to a parent node, wherein the event instance comprises a plurality of entities and a mutual relationship between the entities; and calculating a probability of a cause event instance or an effect event instance having a common parent node. A probability that a first cause event instance causes a first effect event instance equals:

$$P \left(R E 1 \left(R\right) \left|C E 1 \left(C\right)\right)\right) = \frac{P \left(C E 1 \left(R\right) \left|R E 1 \left(C\right)\right)\right) ⋅ P \left(R E 1 \left(R\right)\right)}{P \left(C E 1 \left(C\right)\right)}$$

P(CE1(R) |RE1(C)) represents a probability of the first cause event occurring when the first effect event occurs. P(RE1(R)) represents a probability of the first effect event occurring among all effect events. P(CE1(C)) represents a probability of the first cause event occurring among all cause events.

### CROSS-REFERENCE TO RELATED APPLICATIONS

This application is a U.S. National Stage Application of International Application No. PCT/CN2020/099505 filed Jun. 30, 2020, which designates the United States of America, the contents of which are hereby incorporated by reference in their entirety.

### TECHNICAL FIELD

The present disclosure relates to the field of digitization. Various embodiments of the teachings herein may include semantic-based causal event probability analysis methods, apparatus, and/or systems.

### BACKGROUND

In many applications, knowledge graphs provide the basis for semantic reasoning. However, knowledge graphs are now not configured for causal reasoning due to disadvantages of semantic correlation, dialogs from a semantic space to a probability space, and infeasibility of enumerating events. Specifically, regarding the disadvantages of semantic correlation, it is now generally popular to utilize semantic correlation to describe the correlation between a plurality of entities, such as a bolt, assembly, and a nut. Such a description only describes a semantic relationship, but cannot handle a probabilistic relationship.

Regarding the dialogs from the semantic space to the probability space, a real-world system has many probabilistic relationships to describe different aspects of the system, such as event causes. For example, high temperature of an engine of a vehicle can be caused by lack of lubricating oil or high ambient temperature. Depending on the real cause of the high temperature of the engine, the system needs to have different responses, that is, triggering a low oil alarm or turning on the engine fan. Determination of causality has not been completed in a knowledge graph. Therefore, event causality should be switched from a semantic relationship to a probabilistic relationship, and a connection between events represents a probability of one event causing another.

Regarding the infeasibility of enumerating events, it is impossible to enumerate all events or build a complete model to describe the entire system, because there are always new entities or some exceptions or random situations. Therefore, a single event cannot be described with a fixed description, for example, “robot 1 grabs object 1”, “robot 2 grabs object 2”, or “robot 1 grabs object 1 and places it on table 1”. Enumerating all events is not feasible for real systems.

### SUMMARY

Various teachings of the present disclosure include semantic-based causal event probability analysis methods comprising the following steps: S1. generating at least one cause event instance and a plurality of corresponding effect event instances thereof according to user requirements and based on a cause event template and an effect event template, and assigning each cause event instance or effect event instance to a parent node, wherein the cause event instance or the effect event instance comprises a plurality of entities and a mutual relationship between the entities; and S2. calculating a probability of a cause event instance or an effect event instance having a common parent node, wherein a probability that a first cause event instance causes a first effect event instance is:

$$P \left(\left(R E 1 \left(R\right)\right| C E 1 \left(C\right)\right) = \frac{P \left(\left(C E 1 \left(R\right)\right| R E 1 \left(C\right)\right) ⋅ P \left(R E 1 \left(R\right)\right)}{P \left(C E 1 \left(C\right)\right)}$$

wherein P(CE1(R)|RE1(C)) represents a probability of the first cause event occurring when the first effect event occurs, P(RE1(R)) represents a probability of the first effect event occurring among all effect events, and P(CE1(C)) represents a probability of the first cause event occurring among all cause events.

In some embodiments, step S1 further comprises removing instances having no common parent node.

In some embodiments, step S1 further comprises extracting a plurality of entities from a knowledge base to generate the at least one cause event instance and the plurality of corresponding effect event instances thereof and to form a knowledge graph according to the user requirements and based on the cause event template and the effect event template, and assigning the plurality of entities of each cause event instance or effect event instance to the parent node, wherein the cause event instance or the effect event instance comprises the plurality of entities and the mutual relationship between the entities.

In some embodiments, entities of the cause event template comprise an initial state, an end state, a material relationship, and a material.

In some embodiments, entities of the effect event template comprise an application program, a function module, an execution apparatus, a project, and a module.

In some embodiments, step S2 further includes classifying all cause event instances and effect event instances.

As another example, some embodiments include a semantic-based causal event probability analysis apparatus comprising: a generation apparatus for generating at least one cause event instance and a plurality of corresponding effect event instances thereof according to user requirements and based on a cause event template and an effect event template, and assigning each cause event instance or effect event instance to a parent node, wherein the cause event instance or the effect event instance comprises a plurality of entities and a mutual relationship between the entities; and a calculation apparatus for calculating a probability of a cause event instance or an effect event instance having a common parent node, wherein a probability that a first cause event instance causes a first effect event instance is:

$$P \left(\left(R E 1 \left(R\right)\right| C E 1 \left(C\right)\right) = \frac{P \left(\left(C E 1 \left(R\right)\right| R E 1 \left(C\right)\right) ⋅ P \left(R E 1 \left(R\right)\right)}{P \left(C E 1 \left(C\right)\right)}$$

wherein P(CE1(R)|RE1(C)) represents a probability of the first cause event occurring when the first effect event occurs, P(RE1(R)) represents a probability of the first effect event occurring among all effect events, and P(CE1(C)) represents a probability of the first cause event occurring among all cause events.

In some embodiments, the generation apparatus is further configured to remove instances having no common parent node.

In some embodiments, the generation apparatus is further configured to extract a plurality of entities from a knowledge base to generate the at least one cause event instance and the plurality of corresponding effect event instances thereof and to form a knowledge graph according to the user requirements and based on the cause event template and the effect event template, and assign the plurality of entities of each cause event instance or effect event instance to the parent node, wherein the cause event instance or the effect event instance comprises the plurality of entities and the mutual relationship between the entities.

In some embodiments, entities of the cause event template comprise an initial state, an end state, a material relationship, and a material.

In some embodiments, entities of the effect event template comprise an application program, a function module, an execution apparatus, a project, and a module.

In some embodiments, the calculation apparatus is further configured to classify all cause event instances and effect event instances.

As another example, some embodiments include semantic-based causal event probability analysis system comprising: a processor; and a memory coupled to the processor, wherein the memory stores instructions that, when executed by the processor, cause the electronic device to perform actions comprising: S1. generating at least one cause event instance and a plurality of corresponding effect event instances thereof according to user requirements and based on a cause event template and an effect event template, and assigning each cause event instance or effect event instance to a parent node, wherein the cause event instance or the effect event instance comprises a plurality of entities and a mutual relationship between the entities; and S2. calculating a probability of a cause event instance or an effect event instance having a common parent node, wherein a probability that a first cause event instance causes a first effect event instance is:

$$P \left(\left(R E 1 \left(R\right)\right| C E 1 \left(C\right)\right) = \frac{P \left(\left(C E 1 \left(R\right)\right| R E 1 \left(C\right)\right) ⋅ P \left(R E 1 \left(R\right)\right)}{P \left(C E 1 \left(C\right)\right)}$$

wherein P(CE1(R)|RE1(C)) represents a probability of the first cause event occurring when the first effect event occurs, P(RE1(R)) represents a probability of the first effect event occurring among all effect events, and P(CE1(C)) represents a probability of the first cause event occurring among all cause events.

As another example, some embodiments include a computer program product tangibly stored on a computer-readable medium and comprising computer executable instructions that, when executed, cause at least one processor to perform one or more of the methods as described herein.

As another example, some embodiments include a computer-readable medium storing computer executable instructions that, when executed, cause at least one processor to perform one or more of the methods as described herein.

### BRIEF DESCRIPTION OF THE DRAWINGS

FIG. 1 is a method flowchart of a semantic-based causal event probability analysis method incorporating teachings of the present disclosure;

FIG. 2 is a schematic structural diagram of a cause event template and an effect event template incorporating teachings of the present disclosure;

FIG. 3 is a schematic structural diagram of a cause event instance and an effect event instance incorporating teachings of the present disclosure; and

FIG. 4 is a schematic diagram of calculating an event causal probability relationship incorporating teachings of the present disclosure.

### DETAILED DESCRIPTION

Some embodiments of the teachings herein include a semantic-based causal event probability analysis method, including the following steps: S1. generating at least one cause event instance and a plurality of corresponding effect event instances thereof according to user requirements and based on a cause event template and an effect event template, and assigning each cause event instance or effect event instance to a parent node, where the cause event instance or the effect event instance includes a plurality of entities and a mutual relationship between the entities; and S2. calculating a probability of a cause event instance or an effect event instance having a common parent node, where a probability that a first cause event instance causes a first effect event instance is:

$$P \left(\left(R E 1 \left(R\right)\right| C E 1 \left(C\right)\right) = \frac{P \left(\left(C E 1 \left(R\right)\right| R E 1 \left(C\right)\right) ⋅ P \left(R E 1 \left(R\right)\right)}{P \left(C E 1 \left(C\right)\right)}$$

where P(CE1(R)|RE1(C)) represents a probability of the first cause event occurring when the first effect event occurs, P(RE1(R)) represents a probability of the first effect event occurring among all effect events, and P(CE1(C)) represents a probability of the first cause event occurring among all cause events.

In some embodiments, step S1 further includes removing instances having no common parent node.

In some embodiments, step S1 further includes extracting a plurality of entities from a knowledge base to generate the at least one cause event instance and the plurality of corresponding effect event instances thereof and to form a knowledge graph according to the user requirements and based on the cause event template and the effect event template, and corresponding the plurality of entities of each cause event instance or effect event instance to the parent node, where the cause event instance or the effect event instance includes the plurality of entities and the mutual relationship between the entities.

In some embodiments, entities of the cause event template include an initial state, an end state, a material relationship, and a material.

In some embodiments, entities of the effect event template include an application program, a function module, an execution apparatus, a project, and a module.

In some embodiments, step S2 further includes classifying all cause event instances and effect event instances.

Some embodiments include a semantic-based causal event probability analysis apparatus, including: a generation apparatus for generating at least one cause event instance and a plurality of corresponding effect event instances thereof according to user requirements and based on a cause event template and an effect event template, and assigning each cause event instance or effect event instance to a parent node, where the cause event instance or the effect event instance includes a plurality of entities and a mutual relationship between the entities; and a calculation apparatus for calculating a probability of a cause event instance or an effect event instance having a common parent node, where a probability that a first cause event instance causes a first effect event instance is:

$$P \left(\left(R E 1 \left(R\right)\right| C E 1 \left(C\right)\right) = \frac{P \left(\left(C E 1 \left(R\right)\right| R E 1 \left(C\right)\right) ⋅ P \left(R E 1 \left(R\right)\right)}{P \left(C E 1 \left(C\right)\right)}$$

where P(CE1(R)|RE1(C)) represents a probability of the first cause event occurring when the first effect event occurs, P(RE1(R)) represents a probability of the first effect event occurring among all effect events, and P(CE1(C)) represents a probability of the first cause event occurring among all cause events.

In some embodiments, the generation apparatus is further configured to remove instances having no common parent node.

In some embodiments, the generation apparatus is further configured to extract a plurality of entities from a knowledge base to generate the at least one cause event instance and the plurality of corresponding effect event instances thereof and to form a knowledge graph according to the user requirements and based on the cause event template and the effect event template, and correspond the plurality of entities of each cause event instance or effect event instance to the parent node, where the cause event instance or the effect event instance includes the plurality of entities and the mutual relationship between the entities.

In some embodiments, entities of the cause event template include an initial state, an end state, a material relationship, and a material.

In some embodiments, entities of the effect event template include an application program, a function module, an execution apparatus, a project, and a module.

In some embodiments, the calculation apparatus is further configured to: classify all cause event instances and effect event instances.

Some embodiments include a semantic-based causal event probability analysis system, including: a processor; and a memory coupled to the processor, where the memory stores instructions that, when executed by the processor, cause the electronic device to perform the actions including: S1. generating at least one cause event instance and a plurality of corresponding effect event instances thereof according to user requirements and based on a cause event template and an effect event template, and assigning each cause event instance or effect event instance to a parent node, where the cause event instance or the effect event instance includes a plurality of entities and a mutual relationship between the entities; and S2. calculating a probability of a cause event instance or an effect event instance having a common parent node, where a probability that a first cause event instance causes a first effect event instance is:

$$P \left(\left(R E 1 \left(R\right)\right| C E 1 \left(C\right)\right) = \frac{P \left(\left(C E 1 \left(R\right)\right| R E 1 \left(C\right)\right) ⋅ P \left(R E 1 \left(R\right)\right)}{P \left(C E 1 \left(C\right)\right)}$$

where P(CE1(R)|RE1(C)) represents a probability of the first cause event occurring when the first effect event occurs, P(RE1(R)) represents a probability of the first effect event occurring among all effect events, and P(CE1(C)) represents a probability of the first cause event occurring among all cause events.

Some embodiments include a computer program product tangibly stored on a computer-readable medium and including computer executable instructions that, when executed, cause at least one processor to perform one or more of the methods described herein.

A fifth aspect of the present invention provides a computer-readable medium storing computer executable instructions that, when executed, cause at least one processor to perform one or more of the methods described herein.

Various embodiments reuse a dynamic semantic description of entities and their mutual relationship to automatically generate events and their causality, which reduces costs compared to generating a completely different causality in a network alone. Causality estimation based on an existing semantic description is also more efficient. Because both description methods use the same data set, memory requirements are lowered.

The semantic-based causal event probability analysis mechanism described in the present disclosure converts a static entity relationship into a causal probability, which represents a probability that a specific cause event causes a specific effect event. Causality is directly converted from the semantic description. Therefore, the teachings can convert all existing semantic networks into causal event networks.

### DETAILED DESCRIPTION OF EMBODIMENTS

Specific embodiments of the teachings of the present disclosure are described below in conjunction with the accompanying drawings. Some embodiments include a semantic-based causal event probability analysis mechanism, which is a conversion mechanism from static semantic entity connection to event causality. The method converts a knowledge graph into a causal graph, and switches knowledge description from a relationship description to an event probability description. The teachings are applicable to all single-direction semantic relationships, where each pair of interconnected entities has only one single-direction relationship, that is, a directional graph. Every semantic network needs to include a schema or an ontology, including types and a relationship between the types.

Some embodiments can produce a probabilistic logical layer, which has events on top of a semantic layer. In the case that all semantic descriptions are maintained, a new probabilistic description is added to describe an existing system. The methods and/or systems allow all events at the probabilistic logical layer to be connected with probabilities, which results in a probabilistic connection between events. A probability on each connection is converted into sampling of a newly input entity. In some embodiments, an entity is directly extracted from semantic entities and a relationship therebetween.

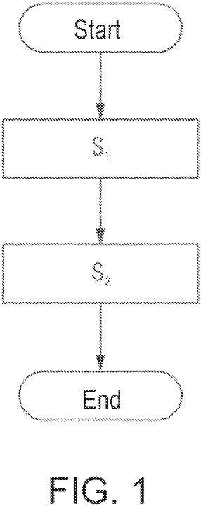

As shown in FIG. 1, a semantic-based causal event probability analysis method may include: First, step S1, in which at least one cause event instance and a plurality of corresponding effect event instances thereof are generated according to user requirements and based on a cause event template and an effect event template, and each cause event instance or effect event instance is assigned to a parent node, where the cause event instance or the effect event instance includes a plurality of entities and a mutual relationship between the entities.

In some embodiments, a client’s requirement is to analyze probabilities of three results caused by changing a stacking state of cartons and pallets to a side-by-side state of the cartons and the pallets. The three results are respectively: a grabbing program uses a first robot; the grabbing program includes a grabbing function block; and the grabbing program creates a grabbing automation project including a controller-controlled displacement calculation module and a controller-controlled gripper control module.

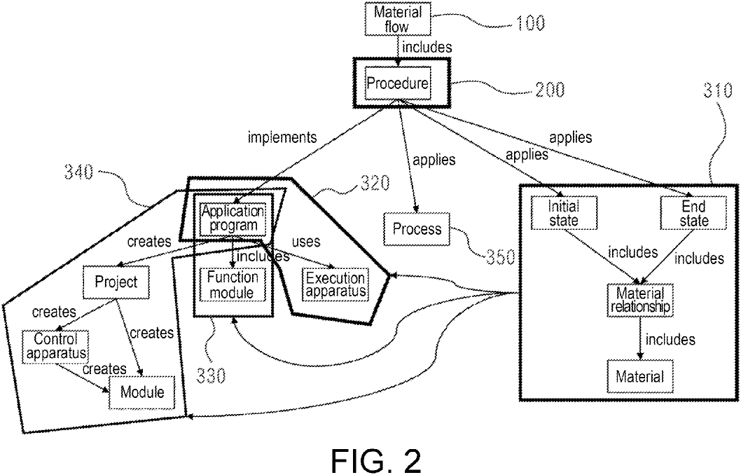

The above instances need to be generated based on templates. As shown in FIG. 2, entities of a cause event template 100 may include an initial state, an end state, a material relationship, and a material; the initial state and the end state each include the material relationship; and the material relationship includes the material. Entities of a first effect event template 320 include an application program and an execution apparatus, where the execution apparatus is a robot, and a relationship between the application program and the robot is that the application program uses the robot. Entities of a second effect event template 330 include the application program and a function module, where the application program includes the function module.

Entities of a third effect event template 340 include the application program, a project, an apparatus, and a module, where the apparatus is a controller, the application program creates the project, the project includes a control apparatus and the module, and the control apparatus controls the module. The cause event template 100, the first effect event template 320, the second effect event template 330, and the third effect event template 340 are under a common parent node template 200. This parent node template 200 is a procedure. The parent node template 200 includes the initial state and the end state in the cause event template 1, and applies a process 350 and is implemented by the application program. In addition, the common parent node template 200 is included under a material flow 100. FIG. 1 shows a causal event model based on a material flow.

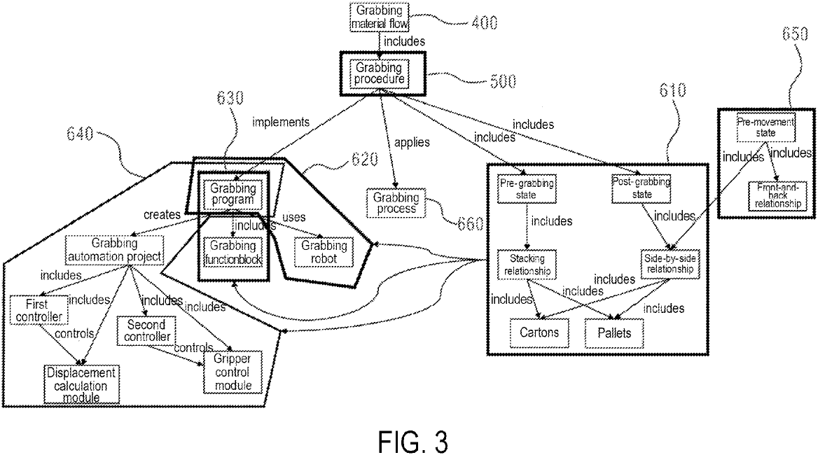

Moreover, there are causal directions between the cause event template and the plurality of effect event templates, and the causal directions usually point from the cause event template to the plurality of effect event templates, respectively. The plurality of effect event templates may include the same entity. Therefore, as shown in FIG. 3, the at least one cause event instance and the plurality of corresponding effect event instances are generated according to the above-mentioned user requirement and based on the above-mentioned templates.

A cause event instance 610 represents “the stacking state of the cartons and the pallets changes to the side-by-side state of the cartons and the pallets”, a first effect event instance 620 represents “the grabbing program uses the first robot”, a second effect event instance 630 represents “the grabbing program includes the grabbing function block”, and a third effect event instance 640 represents “the grabbing program creates the grabbing automation project including the controller-controlled displacement calculation module and the controller-controlled gripper control module”.

Specifically, as shown in FIG. 3, a grabbing material flow 400 includes a grabbing procedure 500. The grabbing procedure 500 serves as a common parent node instance for a cause event instance 610 and its three effect event instances. The grabbing procedure 500 includes a pre-grabbing state and a post-grabbing state. The grabbing procedure 500 applies a grabbing process 660 and implements a grabbing program. The cause event instance 610 includes the following plurality of entities and their mutual relationship: the pre-grabbing state includes a stacking relationship, the post-grabbing state includes a side-by-side relationship, the stacking relationship includes cartons and pallets, and the side-by-side relationship includes the cartons and the pallets. The first effect event instance 620 includes the following plurality of entities and their mutual relationship: a grabbing program uses a grabbing robot. The second effect event instance 630 includes the following plurality of entities and their mutual relationship: the grabbing program includes a grabbing function block. The third effect event instance 640 includes the following plurality of entities and their mutual relationship: the grabbing program creates a grabbing automation project; the grabbing automation project includes a first controller, a displacement calculation module, a second controller, and a gripper control module; the first controller controls the displacement calculation module; and the second controller controls the gripper control module.

In some embodiments, there is an initial state instance or material relationship instance 650 that is not under the same common parent node as the cause event instance 610, the first effect event instance 620, the second effect event instance 630, and the third effect event instance 640. Its entities include a pre-movement state and a front-and-back relationship, where the pre-movement state includes the front-and-back relationship and the side-by-side relationship in the cause event instance 610.

Each class is a sampling space, and its individuals are sampling points in these spaces. An event is a group of individuals included in the class. Therefore, corresponding classes can be selected according to user requirements to generate an event graph. Based on the user requirements, the present invention can define a correlation between event samples by setting a common node, because correlation information of the event samples does not need to be provided by a semantic network. If two event samples do not have a common parent node, they are not correlated.

Specifically, entity classes are selected based on the user requirements to define events, and to define causality between a cause event and an effect event. A common parent node is selected to define a relationship between a cause event and an effect event.

In addition, as required, the user may further input an initial probability between a cause event and an effect event based on expertise or existing data. For example, a probability that the cause event instance 610 is caused by the first effect event instance 620 is 23%, a probability that the cause event instance is caused by the second effect event instance 630 is 10%, and a probability that the cause event instance 610 is caused by the third effect event instance 640 is 52%. The above initial probabilities may be encoded as parameters into causal edges.

In some embodiments, step S1 further includes removing instances having no common parent node. In some embodiments, the initial state instance or material relationship instance 650 that is not under the same common parent node as the cause event instance 610, the first effect event instance 620, the second effect event instance 630, and the third effect event instance 640 is removed.

In some embodiments, step S1 further includes the following steps: extracting a plurality of entities from a knowledge base to generate the at least one cause event instance and the plurality of corresponding effect event instances thereof and to form a knowledge graph according to the user requirements and based on the cause event template and the effect event template, and assigning the plurality of entities of each cause event instance or effect event instance to the parent node, where the cause event instance or the effect event instance includes the plurality of entities and the mutual relationship between the entities. For example, FIG. 3 is a complete knowledge graph.

In some embodiments, step S2 is performed, in which a probability of a cause event instance or an effect event instance having a common parent node is calculated, where a probability that a first cause event instance causes a first effect event instance is:

$$P \left(\left(R E 1 \left(R\right)\right| C E 1 \left(C\right)\right) = \frac{P \left(\left(C E 1 \left(R\right)\right| R E 1 \left(C\right)\right) ⋅ P \left(R E 1 \left(R\right)\right)}{P \left(C E 1 \left(C\right)\right)}$$

where P(CE1(R)|RE1(C)) represents a probability of the first cause event occurring when the first effect event occurs, P(RE1(R)) represents a probability of the first effect event occurring among all effect events, and P(CE1(C)) represents a probability of the first cause event occurring among all cause events. Step S2 further includes the following step: classifying all cause event instances and effect event instances. For example, in the following embodiment, they are classified into a first-class cause event, a first-class effect event, a second-class effect event, and so on.

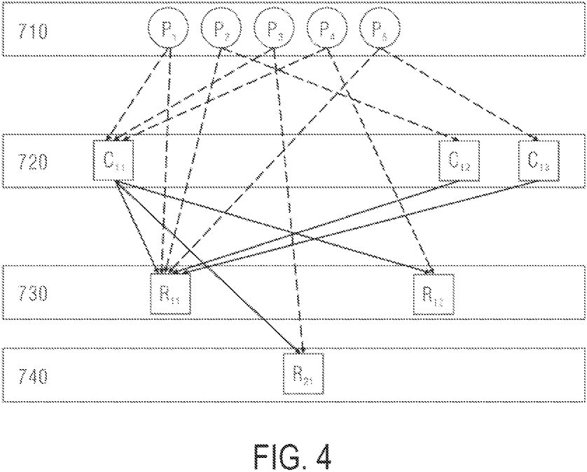

As shown in FIG. 4, a first-class cause event 720 includes boiler damage C₁₁, insufficient power supply C₁₂, and insufficient inventory C₁₃. A first-class effect event 730 includes stopping the pipeline R₁₁ and stopping the shipping R₁₂. A second-class effect event 740 includes shutdown R₂₁. The solid arrows in FIG. 4 represent “causes”, that is, the cause event causes the effect event. Specifically, the first-class cause event “boiler damage C₁₁” may cause the first-class effect events “stopping the pipeline R₁₁” and “stopping the shipping R₁₂” and the second-class effect event “shutdown R₂₁”. The first-class cause event “insufficient power supply C₁₂” may cause the first-class effect event “stopping the pipeline R₁₁”. The first-class cause event “insufficient inventory C₁₃” may cause “stopping the pipeline R₁₁”. The dashed arrows in FIG. 4 represent a common parent node. For example, “Wuhan factory P₁” is a common parent node of the first-class cause event “boiler damage C₁₁” and the first-class effect event “stopping the pipeline R₁₁”. “Shanghai factory P₂” is a common parent node of the first-class effect event “stopping the pipeline R₁₁” and the first-class cause event “insufficient power supply C₁₂”. “Beijing factory P₃” is a common parent node of the first-class cause event “boiler damage C₁₁” and the second-class effect event “shutdown R₂₁”.

“Xi’an factory P₄” is a common parent node of the first-class cause event “boiler damage C₁₁” and the first-class cause event “stopping the shipping R₁₂”. “Chengdu factory P₅” is a common parent node of the first-class effect event “stopping the pipeline R₁₁” and the first-class cause event “insufficient inventory C₁₂”. Therefore, the entire graph is layered and classified according to a common parent node layer, a first-class cause event layer, a first-class effect event layer, and a second-class effect event layer.

FIG. 4 is converted into Table 1 of connection event samples as follows:

| | | |
|---|---|---|
| Common parent node | Cause event sample | Effect event sample |
| P₁ | C₁₁ | R₁₁ |
| P₂ | C₁₂ | R₁₂ |
| P₃ | C₁₁ | R₂₁ |
| P₄ | C₁₁ | R₁₁ |
| P₅ | C₁₃ | R₁₁ |

The above cause event sample needs to have a corresponding common parent node with the effect event sample, and the common parent node is to be used as an index for calculating the samples, and initializes calculation of a probability between the cause event sample and the effect event sample.

Specifically, in FIG. 4, there are five common child nodes, three cause event samples (C₁₁, C₁₂, C₁₃), two first-class effect event samples (R₁₁, R₁₂), and one second-class effect event sample (R₂₁) . As shown in Table 1, a probability of boiler damage C₁₁ and stopping the pipeline R₁₁ is expressed as:

$$P \left(\left(R E 1 \left({R}_{11}\right)\right| C E 1 \left({C}_{11}\right)\right) = \frac{P \left(\left(C E 1 \left({R}_{11}\right)\right| R E 1 \left({C}_{11}\right)\right) ⋅ P \left(R E 1 \left({R}_{11}\right)\right)}{P \left(C E 1 \left({C}_{11}\right)\right)}$$

Therefore, it can be easily calculated from Table 1:

$$P \left(R E 1 \left({R}_{11}\right) \left|C E 1\right) \left({C}_{11}\right)\right) = \frac{\frac{2}{3} ⋅ \frac{3}{5}}{\frac{3}{5}} = \frac{2}{3}$$

In some embodiments, a semantic-based causal event probability analysis apparatus includes: a generation apparatus for generating at least one cause event instance and a plurality of corresponding effect event instances thereof according to user requirements and based on a cause event template and an effect event template, and assigning each cause event instance or effect event instance to a parent node, where the cause event instance or the effect event instance includes a plurality of entities and a mutual relationship between the entities; and a calculation apparatus for calculating a probability of a cause event instance or an effect event instance having a common parent node, where a probability that a first cause event instance causes a first effect event instance is:

$$P \left(\left(R E 1 \left(R\right)\right| C E 1 \left(C\right)\right) = \frac{P \left(\left(C E 1 \left(R\right)\right| R E 1 \left(C\right)\right) ⋅ P \left(R E 1 \left(R\right)\right)}{P \left(C E 1 \left(C\right)\right)}$$

where P(CE1(R)|RE1(C)) represents a probability of the first cause event occurring when the first effect event occurs, P(RE1(R)) represents a probability of the first effect event occurring among all effect events, and P(CE1(C)) represents a probability of the first cause event occurring among all cause events.

In some embodiments, the generation apparatus is further configured to remove instances having no common parent node.

In some embodiments, the generation apparatus is further configured to extract a plurality of entities from a knowledge base to generate the at least one cause event instance and the plurality of corresponding effect event instances thereof and to form a knowledge graph according to the user requirements and based on the cause event template and the effect event template, and assign the plurality of entities of each cause event instance or effect event instance to the parent node, where the cause event instance or the effect event instance includes the plurality of entities and the mutual relationship between the entities.

In some embodiments, entities of the cause event template include an initial state, an end state, a material relationship, and a material.

In some embodiments, entities of the effect event template include an application program, a function module, an execution apparatus, a project, and a module.

In some embodiments, the calculation apparatus is further configured to classify all cause event instances and effect event instances.

In some embodiments, a semantic-based causal event probability analysis system includes: a processor; and a memory coupled to the processor, where the memory stores instructions that, when executed by the processor, cause the electronic device to perform the actions including: S1. generating at least one cause event instance and a plurality of corresponding effect event instances thereof according to user requirements and based on a cause event template and an effect event template, and assigning each cause event instance or effect event instance to a parent node, where the cause event instance or the effect event instance includes a plurality of entities and a mutual relationship between the entities; and S2. calculating a probability of a cause event instance or an effect event instance having a common parent node, where a probability that a first cause event instance causes a first effect event instance is:

$$P \left(\left(R E 1 \left(R\right)\right| C E 1 \left(C\right)\right) = \frac{P \left(\left(C E 1 \left(R\right)\right| R E 1 \left(C\right)\right) ⋅ P \left(R E 1 \left(R\right)\right)}{P \left(C E 1 \left(C\right)\right)}$$

where P(CE1(R)|RE1(C)) represents a probability of the first cause event occurring when the first effect event occurs, P(RE1(R)) represents a probability of the first effect event occurring among all effect events, and P(CE1(C)) represents a probability of the first cause event occurring among all cause events.

In some embodiments, there is a computer program product tangibly stored on a computer-readable medium and including computer executable instructions that, when executed, cause at least one processor to perform one or more of the methods described herein.

In some embodiments, there is a computer-readable medium storing computer executable instructions that, when executed, cause at least one processor to perform one or more of the methods described herein.

Some embodiments can reuse a dynamic semantic description of entities and their mutual relationship to automatically generate events and their causality, which reduces costs compared to generating a completely different causality in a network alone. In some embodiments, causality estimation based on an existing semantic description is also more efficient. Because both description methods use the same data set, memory requirements are lowered.

The semantic-based causal event probability analysis mechanism provided in the present disclosure converts a static entity relationship into a causal probability, which represents a probability that a specific cause event causes a specific effect event. Causality is directly converted from the semantic description. Therefore, the embodiments can convert all existing semantic networks into causal event networks.

Although the content of the present disclosure has been described in detail in the embodiments above, it should be appreciated that the description above should not be considered as a limitation on the present disclosure. Various modifications and substitutions to the embodiments described will be apparent after perusal of the content above by those skilled in the art. Thus, the scope of protection of the present disclosure should be defined by the appended claims. Moreover, any of the reference numerals in the claims shall not be construed as limiting the claims concerned. The term “include/comprise” does not exclude other apparatuses or steps not listed in the claims or the description. The terms “first”, “second”, etc., are only used to refer to names, and do not denote any particular order.

What is claimed is:

1. A semantic-based causal event probability analysis method comprising:
generating at least one cause event instance and a plurality of corresponding effect event instances thereof according to user requirements and based on a cause event template and an effect event template;
assigning each cause event instance or effect event instance to a parent node, wherein the cause event instance or the effect event instance comprises a plurality of entities and a mutual relationship between the entities; and
calculating a probability of a cause event instance or an effect event instance having a common parent node;
wherein a probability that a first cause event instance causes a first effect event instance is:
$$P \left(R E 1 \left(R\right) \left|C E 1 \left(C\right)\right)\right) = \frac{P \left(C E 1 \left(R\right) \left|R E 1 \left(C\right)\right)\right) ⋅ P \left(R E 1 \left(R\right)\right)}{P \left(C E 1 \left(C\right)\right)}$$
P(CE1(R)|RE1(C)) represents a probability of the first cause event occurring when the first effect event occurs;
P(RE1(R)) represents a probability of the first effect event occurring among all effect events; and
P(CE1(C)) represents a probability of the first cause event occurring among all cause events.

2. The semantic-based causal event probability analysis method as claimed in claim 1, further comprising removing instances having no common parent node.

3. The semantic-based causal event probability analysis method as claimed in claim 1, the method further comprising: extracting a plurality of entities from a knowledge base to generate the cause event instance and the plurality of corresponding effect event instances thereof and to form a knowledge graph according to the user requirements; and
based on the cause event template and the effect event template, and assigning the plurality of entities of each cause event instance or effect event instance to the parent node;
wherein the cause event instance or the effect event instance comprises the plurality of entities and the mutual relationship between the entities.

4. The semantic-based causal event probability analysis method as claimed in claim 1, wherein entities of the cause event template comprise: an initial state, an end state, a material relationship, and a material.

5. The semantic-based causal event probability analysis method as claimed in claim 1, wherein entities of the effect event template comprise: an application program, a function module, an execution apparatus, a project, and a module.

6. The semantic-based causal event probability analysis method as claimed in claim 1, the method further comprising classifying all cause event instances and effect event instances.

7. A semantic-based causal event probability analysis apparatus comprising:
a generation apparatus for generating a cause event instance and a plurality of corresponding effect event instances thereof according to user requirements and based on a cause event template and an effect event template and assigning each cause event instance or effect event instance to a parent node;
wherein the cause event instance or the effect event instance comprises a plurality of entities and a mutual relationship between the entities; and
a calculation apparatus for calculating a probability of a cause event instance or an effect event instance having a common parent node;
wherein a probability that a first cause event instance causes a first effect event instance is:
$$P \left(R E 1 \left(R\right) \left|C E 1 \left(C\right)\right)\right) = \frac{P \left(C E 1 \left(R\right) \left|R E 1 \left(C\right)\right)\right) ⋅ P \left(R E 1 \left(R\right)\right)}{P \left(C E 1 \left(C\right)\right)}$$
P(CE1(R)|RE1(C)) represents a probability of the first cause event occurring when the first effect event occurs;
P(RE1(R)) represents a probability of the first effect event occurring among all effect events; and
P(CE1(C)) represents a probability of the first cause event occurring among all cause events.

8. The semantic-based causal event probability analysis method as claimed in claim 7, wherein the generation apparatus is further configured toremove instances having no common parent node.

9. The semantic-based causal event probability analysis method as claimed in claim 7, wherein the generation apparatus is further configured to extract a plurality of entities from a knowledge base to generate the at least one cause event instance and the plurality of corresponding effect event instances thereof and to form a knowledge graph according to the user requirements and based on the cause event template and the effect event template, and assign the plurality of entities of each cause event instance or effect event instance to the parent node, wherein the cause event instance or the effect event instance comprises the plurality of entities and the mutual relationship between the entities.

10. The semantic-based causal event probability analysis method as claimed in claim 7, wherein entities of the cause event template comprise: an initial state, an end state, a material relationship, and a material.

11. The semantic-based causal event probability analysis method as claimed in claim 7, wherein entities of the effect event template comprise: an application program, a function module, an execution apparatus, a project, and a module.

12. The semantic-based causal event probability analysis method as claimed in claim 7, wherein the calculation apparatus is further configured toclassify all cause event instances and effect event instances.

13. A semantic-based causal event probability analysis system comprising:
a processor; and
a memory coupled to the processor, wherein the memory stores instructions that, when executed by the processor, cause the electronic device to:
generate a cause event instance and a plurality of corresponding effect event instances thereof according to user requirements and based on a cause event template and an effect event template, and assigning each cause event instance or effect event instance to a parent node, wherein the cause event instance or the effect event instance comprises a plurality of entities and a mutual relationship between the entities; and
calculate a probability of a cause event instance or an effect event instance having a common parent node, wherein a probability that a first cause event instance causes a first effect event instance is:
$$P \left(R E 1 \left(R\right) \left|C E 1 \left(C\right)\right)\right) = \frac{P \left(C E 1 \left(R\right) \left|R E 1 \left(C\right)\right)\right) ⋅ P \left(R E 1 \left(R\right)\right)}{P \left(C E 1 \left(C\right)\right)}$$
wherein P(CE1(R)|RE1(C)) represents a probability of the first cause event occurring when the first effect event occurs;
P(RE1(R)) represents a probability of the first effect event occurring among all effect events; and
P(CE1(C)) represents a probability of the first cause event occurring among all cause events.

14-15. (canceled)
